(19) United States
(12) Patent Application Publication
(10) Pub. No.: US 2025/0340352 A1
(43) Pub. Date: Nov. 6, 2025

(54) Products, Containers And Methods For Storing Frozen Food Sensitive To Low Temperatures

(71) Applicant: Gail Kurpgeweit, Scottsdale, AZ (US)

(72) Inventor: Gail Kurpgeweit, Scottsdale, AZ (US)

(21) Appl. No.: 18/663,462

(22) Filed: May 14, 2024

Related U.S. Application Data
(63) Continuation-in-part of application No. 18/196,021, filed on May 11, 2023, now abandoned.

(51) Int. Cl. B65D 77/04; A23B 2/80; A23G 9/20; A23L 2/00; B65B 3/00; B65B 5/04; B65B 7/28; B65B 25/00; B65D 65/38; F25D 31/00

(52) U.S. Cl. CPC B65D 77/0406; A23B 2/8055; A23G 9/20; A23L 2/00; B65B 3/00; B65B 5/045; B65B 7/28; B65B 25/007; B65D 65/38; F25D 31/00; B65B 2220/16; B65D 2565/387

(57) ABSTRACT

Products, containers and methods for storing food that is sensitive to low temperatures in freezers are provided. The products comprise a food and a storage unit, and the storage unit comprises a first container that contains the food and a second container that holds the first container and the food and which provides a space between the first container and the second container. The storage unit is used in methods to freeze and thaw the food that result in the food having its desired or original consistency after the food is thawed.

### CROSS REFERENCE TO RELATED APPLICATIONS

This application claims the benefit and is a continuation in part application of U.S. application Ser. No. 18/196,021, filed on May 11, 2023, which is hereby incorporated by reference herein in its entirety.

### FIELD OF THE INVENTION

The invention relates to products, containers and methods for storing frozen foods.

### BACKGROUND OF THE INVENTION

Certain frozen food products are sensitive to the low temperature at which they are stored. This includes soft-serve ice cream, ice cream-based milkshakes and other beverages, blended fruit, vegetable and/or other food containing smoothies, and other products. For example, storing soft-serve ice cream and ice cream-based milkshakes for retail sale is exceptionally difficult because they are created at around 15-23 degrees Fahrenheit while grocery store freezers are typically set at −3 to 5 degrees Fahrenheit. With traditional packaging, when soft-serve ice cream and ice cream-based milkshakes are frozen to under about 10 degrees Fahrenheit and then thawed, they lose their original consistency and become over-crystallized, watery in part, and clumpy and they never regain their prior smooth state.

For this reason, pre-made soft-serve ice cream, ice cream-based milkshakes, blended smoothies, and other products stored in commonly used containers are generally not sold in grocery stores and other venues for purchase and later consumption by consumers. Commonly used low temperature freezers turn the contents into solid bricks instead of their desired consistency (e.g., smooth beverages that can be consumed through a straw). When thawed, they become over-crystallized, watery in part, and clumpy, and they do not retain their original consistency.

Therefore, containers and methods of storage are needed for warehousing, shipping, storing, and selling sensitive frozen foods, such as soft-serve ice cream, ice cream-based milkshakes, fruit, vegetable and/or other food containing smoothies, and other products, in which the products can be stored before sale and regain their desired consistency before consumption by the consumer. If such containers and methods of storage could be used with common and/or universal freezer equipment at common temperatures used in warehouses, shipping, and prior to sale (e.g., grocery stores and big-box retailers), it would forgo the need for specialized freezer equipment and temperatures, permit the foods to be pre-made, and thus widen the availability of the foods, which may make them less expensive to the consumer because they are no longer required to be made at the point of sale and the consumer may benefit from having additional food choices and/or the economies of scale.

### SUMMARY OF THE INVENTION

Embodiments of this invention may provide the product composition, containers and methods of storage that are needed for such sensitive frozen foods. This invention comprises products, containers and methods that improve the storage and availability of frozen foods that are sensitive to low temperature freezers. The foods include milk containing products, such as soft-serve ice cream and ice cream-based beverages (e.g., milkshakes), as well as fruit, vegetable and/or other food containing smoothies (smoothies are generally thick, smooth drinks of pureed foods), and other sensitive products. Different foods that may be sensitive to the low temperature of many of the freezers used in warehouses, shipping equipment (e.g., shipping containers, trailers, trucks), grocery stores, restaurants, and those associated with other wholesale and retail sales can benefit from embodiments of this invention.

Certain embodiments of this invention comprise a soft-serve ice cream product that can be stored in a freezer with temperatures below about 10 degrees Fahrenheit, removed, thawed to about 20 degrees Fahrenheit and then consumed without it losing its desired and original consistency (stirring may be required for some foods). Other embodiments comprise an ice-cream based beverage (e.g., milkshake) product that can be stored in a freezer with temperatures below about 10 degrees Fahrenheit, removed, thawed to about 20 degrees Fahrenheit and then consumed without it losing its desired and original consistency. Still other embodiments comprise a blended smoothie product that can be stored in a freezer with temperatures below about 10 degrees Fahrenheit, removed, thawed to about 20 degrees Fahrenheit and then consumed without it losing its desired and original consistency.

Certain embodiments of this invention comprise storage units for the storage of a food that is sensitive to low temperatures (e.g., below about 10 degrees Fahrenheit) that comprise a first container (e.g., an insulating paper-containing cup or carton with a lid) that directly holds the food inside it. This first container is then placed inside a second container (e.g., a plastic closeable pouch) that provides a sealed or closed air space between at least a portion of the first container and the second container (e.g., at least about 50% of the outside area of the first container has an air space), and preferably an air space that is at least at the sides of the first container and the interior of the second container.

Other embodiments of this invention comprise methods of storing a food that is sensitive to low temperatures (e.g., below about 10 degrees Fahrenheit) so that it can regain its desired consistency before consumption, the method comprising placing the food in a first container (e.g., an insulating paper-containing cup or carton with a lid) that directly holds the food inside it. This first container is then placed inside a second container (e.g., a plastic closeable pouch) that provides a sealed or closed air space between at least a portion of the first container and the second container (e.g., at least about 50% of the outside area of the first container has an air space), and preferably an air space that is at least at the sides of the first container and the interior of the second container.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a perspective view of an embodiment of a second container.

FIG. 2 is a side view of an embodiment of a second container.

FIG. 3 is a perspective and cutaway view of an embodiment of a second container showing an embodiment of a first container inside. The first container and the second container together form a storage unit of this invention.

FIG. 4 is a perspective view of an embodiment of a second container.

FIG. 5 is a perspective and cutaway view of an embodiment of a second container showing an embodiment of a first container inside. The first container and the second container together form a storage unit of this invention.

FIG. 6 is a perspective view of an embodiment of a second container.

FIG. 7 is a perspective and cutaway view of an embodiment of a second container showing four embodiments of a first container inside. The first container and the second container together form a storage unit of this invention.

FIG. 8 is a perspective view of an embodiment of a second container.

FIG. 9 is a perspective and cutaway view of an embodiment of a second container showing four embodiments of a first container inside. The first container and the second container together form a storage unit of this invention.

FIG. 10 is a perspective view of an embodiment of a second container.

FIG. 11 is a perspective and cutaway view of an embodiment of a second container showing three embodiments of a first container inside. The first container and the second container together form a storage unit of this invention.

### DETAILED DESCRIPTION OF THE INVENTION

A number of foods can benefit from this invention. This includes soft-serve ice cream products, ice cream-based beverage (e.g., milkshake) products, and blended smoothie products that can be stored in standard freezers and then thawed and used without them losing their desired and original consistencies.

The storage unit of this invention comprises at least two components. One component is the first container, which contains the food. A second component is the second container, which holds the first container and provides a sealed or closed air space between portions of the two containers (e.g., space between the first container and the second container where the two containers are not touching). While this space is called “air space” herein, besides actual “air”, it can be other gases and collections or mixtures of gases used in food manufacturing, warehousing, shipping and storage (e.g., nitrogen gas, argon gas, atmospheric air).

The first container preferably comprises a paper-containing material and a lid, of the same or different material. In the most preferred embodiments, the first container is made of material that is freezer safe, heat resistant, and which can be microwaved in order to heat it. Preferred embodiments of the first container provide insulation to the food that is contained within it, specifically providing at least some protection against temperature changes and variations from outside the container. The inside portion of the first container that contacts the food should safety do so.

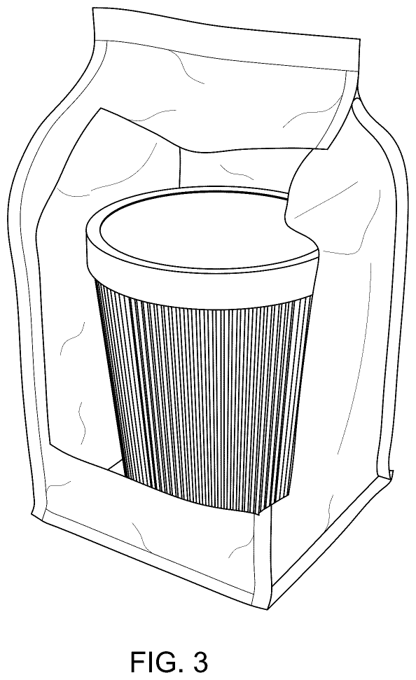

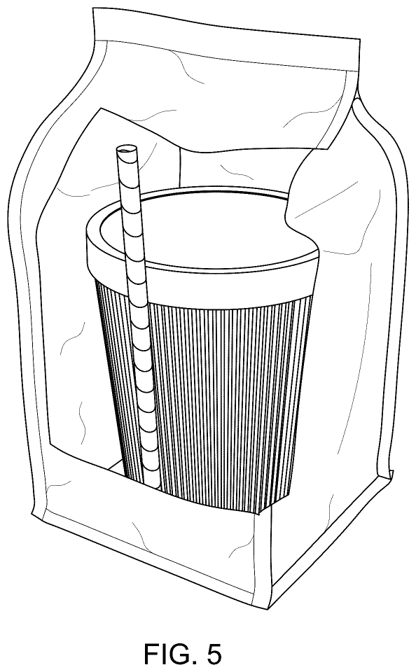

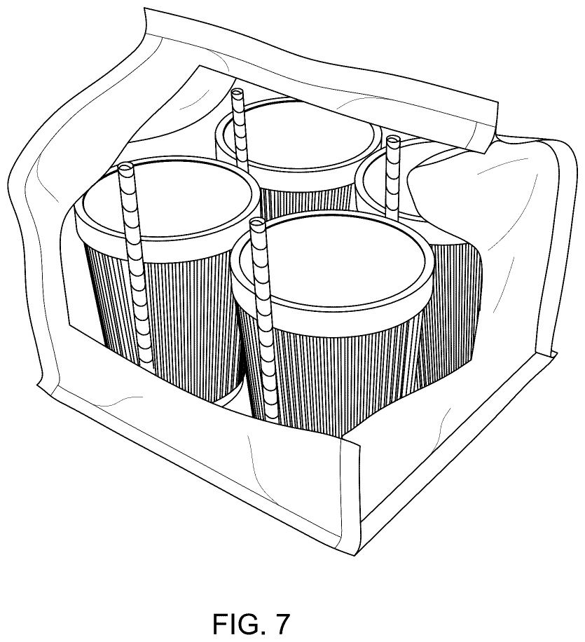

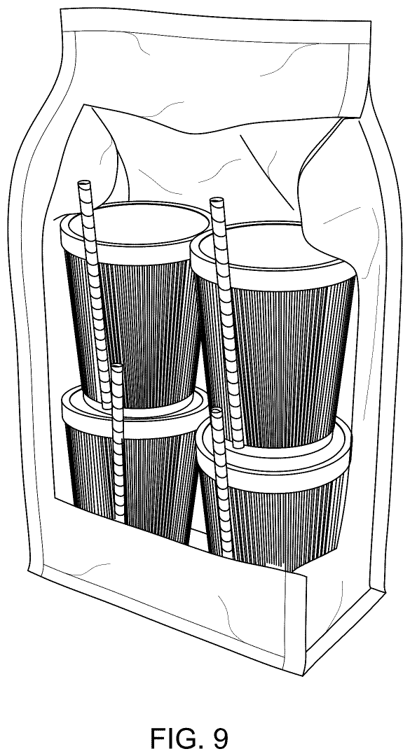

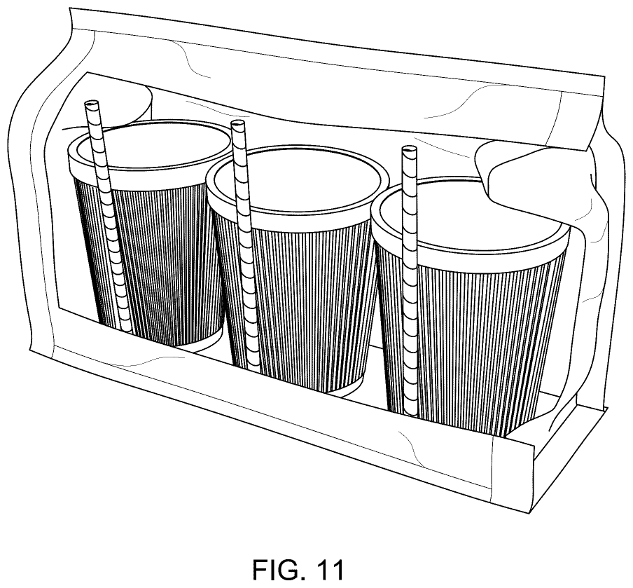

The first container can be made of different materials and combinations of materials. Specific examples of a first container include the paper-containing cartons that hold ice cream that is sold in grocery stores. These cartons may be lined with materials that concern food storage (e.g., food safe materials, oxygen barriers, non-absorbing materials). The first container may be comprised of wet-strength paperboard with a polyethylene lining in certain embodiments. A person of skill in the art will recognize materials that can be used for storage of food, which can be used herein. FIGS. 3, 5, 7, 9, and 11 show preferred embodiments of the first container.

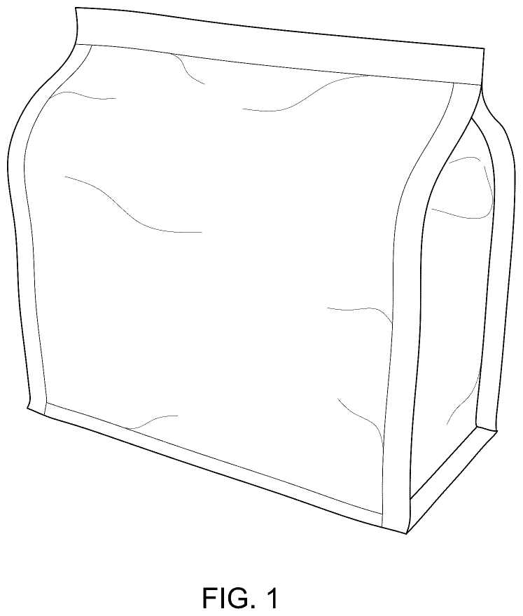

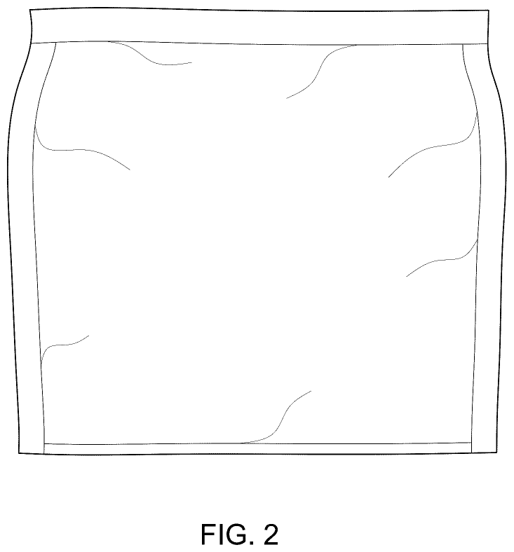

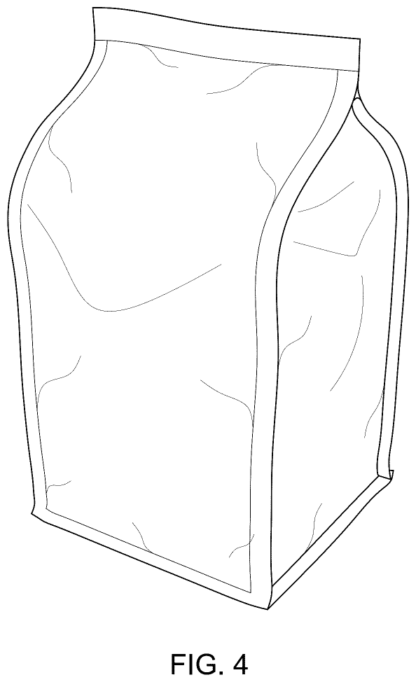

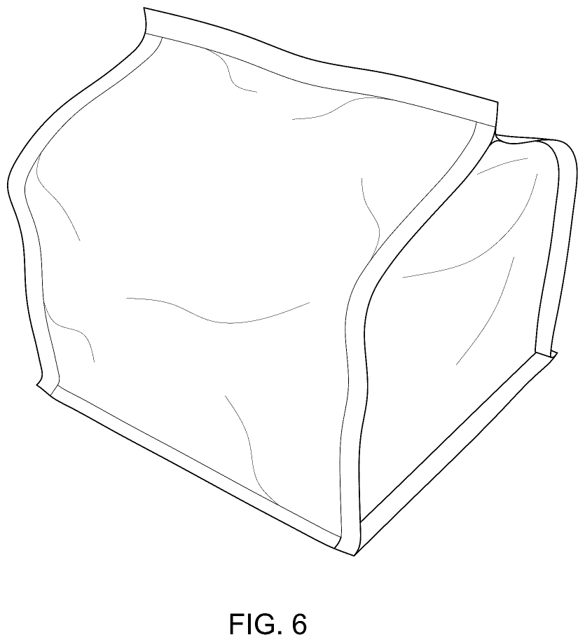

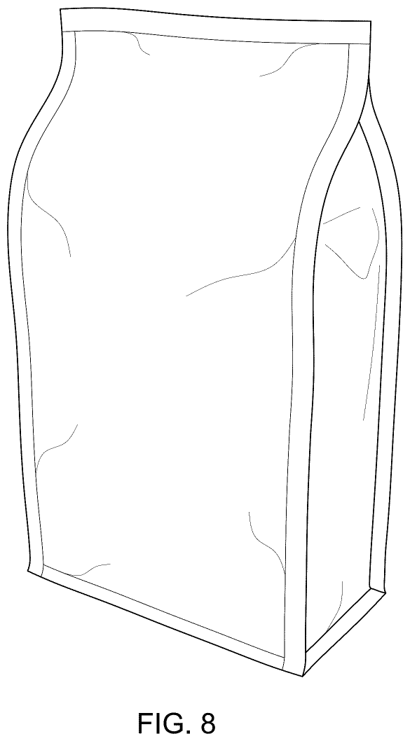

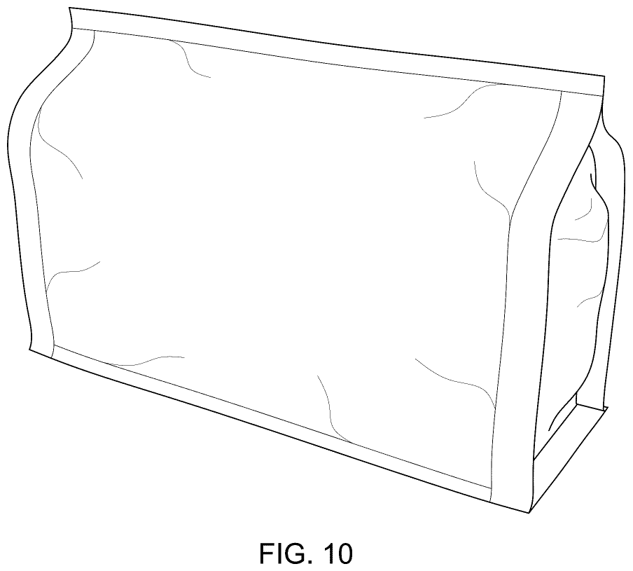

The second container holds the first container and both containers together are referred to as a storage unit herein. FIGS. 1-11 show embodiments of the second container. The second container preferably comprises a closable pouch that can stand upright (e.g., via a bottom portion designed to stand on a surface, and which has at least some resistance to tipping over without being pushed). The second container most preferably can be closed to be air-tight, or nearly air-tight, or “sealed”, under common handling conditions (e.g., moving the storage unit into a freezer, removing the storage unit out of the freezer and taking it to a consumer's residence for consumption). It is important that there is space within the second container that is not the first container (e.g., air space), as is described herein. The amount of airspace is preferably a minimum of ½ inch around at least about 50% of the sides of the first container, more preferably a minimum of ⅝ of an inch, and most preferably a minimum of ¾ of an inch.

The second container can be made of different materials and combinations of materials. For example, a plastic can be used. In addition, additional layers can be added to the second container, such as a vapor barrier film or other material that provides a vapor barrier or other property or characteristic that a person of skill in the art recognizes improves storage capabilities. In certain embodiments, a vapor barrier sheet of plastic (e.g., nylon, polyethylene, polyester, Tyvek), which may be fortified (e.g., with aluminum), is used to form the second container, or otherwise contained therein. Other Volatile Corrosion Inhibitors and other vapor barriers are known to a person of skill in the art and can be adapted to be used in or with the second container. In the most preferred embodiments, the second container provides high thermal protection that prevents the crystallization of water in the product, and which then permits the product to be thawed back to its original consistency without significant crystallization.

Foods that may be sensitive to the low temperature of many of the freezers used in warehouses, shipping equipment (e.g., shipping containers, trailers, trucks), grocery stores, restaurants, and those associated with other wholesale and retail sales may be those that benefit most from embodiments of this invention.

This invention comprises food products (i.e., the term food “products” is used herein to mean food with containers for sale and use) that improve the storage and availability of foods when they are frozen when the foods are sensitive to low temperature freezers. After storage in a freezer, and thawed to about 20 degrees Fahrenheit (or another temperature appropriate for the particular food), the food will have its original consistency (after stirring in some instances), without an undue amount of crystallization, wateriness, breakdown, etc.

This invention also comprises containers (e.g., a storage unit, first container, second container) and methods that improve the storage and availability of such foods when they are frozen when they are sensitive to low temperature freezers. There is a wide variety of such foods. These include dairy (e.g., milk, yogurt) and nut milk containing products, such as soft-serve ice cream and ice cream-based milkshakes. These also include fruit smoothies, vegetable smoothies, and smoothies that are combinations of fruits, vegetable and/or other foods.

The storage units comprised of first and second containers of this invention can be used in methods to store food. The food can be manufactured, processed, mixed, or filled into a first container. A lid or other closure device can be then installed or closed over the first container. The first container can then be placed in the second container. There should be at least some air space between the first container and the inside portions of the second container. The second container is then closed and the storage unit is complete and ready for storage.

The freezer storage can be done in any step in the supply chain of the product. This can include, for example, at the manufacturer, in a warehouse, in a shipping device (e.g., shipping container, freezer truck, freezer trailer), grocery freezer, big box freezer, wholesaler freezer, other retailer freezer, restaurant freezer, or a consumer's or other end user's freezer.

When the end consumer or user (e.g., restaurant) is ready to use the food, they can remove the storage unit from the freezer and, for example, place it on a countertop or table at ambient or room temperature for about 10 to about 15 minutes or so (depending on the food and the size of the container, temperature in the room, etc.) and the food will be ready to be consumed and it will have the desired consistency. For example, this amount of time may be enough to thaw soft-serve ice cream or an ice cream-based milkshake to about 20 Fahrenheit, which is a favorable temperature for consumption. Preferably, the food is allowed to come to a temperature of between about 18 to about 22 degrees Fahrenheit before consuming, and most preferably about 20 degrees Fahrenheit.

Alternatively, when the end consumer or user (e.g., restaurant) is ready to use the food, they can remove the storage unit from the freezer and, for example, place it in a microwave (or other oven) for a short amount of time (e.g., about 10 seconds at a medium power level or so (depending on the food and the size of the container, temperature in the room, etc.)) and the food will be ready to be consumed and it will have the desired consistency. For example, this amount of time may be enough to thaw soft-serve ice cream or an ice cream-based milkshake to about 20 Fahrenheit, which is a favorable temperature for consumption. Preferably, the food is allowed to come to a temperature of between about 18 to about 22 degrees Fahrenheit before consuming, and most preferably about 20 degrees Fahrenheit.

Certain embodiments of this invention may provide a better final product that when ready to be used by the end user, there is less crystallization, less clumpy-ness, less wateriness, and/or less changed texture or consistency (e.g., smoothness, creaminess) than if this invention is not used. Preferably, after using embodiments of this invention there is 50% less crystallization, more preferably there is 75% less crystallization and most preferably there is 90% less crystallization. The most desired result, however, is for the thawed food to have the original consistency it had when it was first made, with or without stirring.

The advantages from certain embodiments of this invention are that it provides containers and methods of storage for warehousing, shipping, storing, and selling sensitive frozen foods, such as soft-serve ice cream, ice cream-based beverages (e.g., milkshakes), fruit, vegetable and/or other food containing smoothies, and other products, in which the products can be stored before sale and regain their desired consistency before consumption by the consumer (e.g., individual person, restaurant).

Other advantages from certain embodiments of this invention include containers and methods of storage that can be used with sensitive foods that are stored in common and/or universal freezer equipment at common temperatures used in warehouses, shipping, and prior to sale (e.g., grocery stores and big-box retailers).

Another advantage of embodiments of this invention is that they may forgo the need for specialized freezer equipment and temperatures for certain foods.

Another advantage of certain embodiment of this invention is that they may permit certain foods to be pre-made, that could not be pre-made before, and thus widen the availability of the foods. This may make the foods less expensive to the consumer or other end user because the foods would no longer need to be made at the point of sale and the consumer and other end users may benefit from the wide availability of the products and the economies of scale.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

This example provides a product comprising a soft-serve ice cream food and a storage unit for the food. The soft-serve ice cream has an original consistency when it is made that is desired and smooth (or mostly smooth if it contains bits and pieces of other foods, like fruits and nuts), for example.

The storage unit comprises a first container and a second container. The first container comprises a paper-containing material (e.g., wet strength paperboard with a polyethylene lining) and a lid of the same or different material. The second container comprises a vapor barrier material (e.g., made of a sheet of plastic (e.g., nylon, polyethylene, polyester, Tyvek) fortified with aluminum)). The second container is closable (e.g., sealable and/or air-tight) and it maintains a space between portions of the second container and at least about 50% of the outside area of the first container.

To prepare the product, the soft-serve ice cream is added to the first container and then the first container with the soft-serve ice cream is added to the second container to form the storage unit. The storage unit can then be added to a freezer for storage, including a freezer that is kept below about 10 degrees Fahrenheit.

When the storage unit with the food is removed from the freezer, it is then partially thawed (e.g., by leaving it out in a room or microwaving) to a temperature consistent with the specific food, which is often to about 20 degrees Fahrenheit, before serving. At that point, the food is ready to be consumed (it might benefit from stirring), and it will be found to have its original consistency, without undue crystallization, clumpy-ness, wateriness or breakdown of the food.

### Example 2

This example provides a product comprising an ice cream-based beverage (e.g., milkshake) food and a storage unit for the food. The ice cream-based beverage has an original consistency when it is made that is desired and smooth (or mostly smooth if it contains bits and pieces of other foods, like fruits and nuts), for example.

The storage unit comprises a first container and a second container. The first container comprises a paper-containing material (e.g., wet strength paperboard with a polyethylene lining) and a lid of the same or different material. The second container comprises a vapor barrier material (e.g., made of a sheet of plastic (e.g., nylon, polyethylene, polyester, Tyvek) fortified with aluminum)). The second container is closable (e.g., sealable and/or air-tight) and it maintains a space between portions of the second container and at least about 50% of the outside area of the first container.

To prepare the product, the ice cream-based beverage is added to the first container and then the first container with the ice cream-based beverage is added to the second container to form the storage unit. The storage unit can then be added to a freezer for storage, including a freezer that is kept below about 10 degrees Fahrenheit.

When the storage unit with the food is removed from the freezer, it is then partially thawed (e.g., by leaving it out in a room or microwaving) to a temperature consistent with the specific food, which is often to about 20 degrees Fahrenheit, before serving. At that point, the food is ready to be consumed (it might benefit from stirring), and it will be found to have its original consistency, without undue crystallization, clumpy-ness, wateriness or breakdown of the food.

### Example 3

This example provides a product comprising a blended smoothie food and a storage unit for the food. The blended smoothie has an original consistency when it is made that is desired and smooth (comprising pureed fruits, vegetables and/or other foods), for example.

The storage unit comprises a first container and a second container. The first container comprises a paper-containing material (e.g., wet strength paperboard with a polyethylene lining) and a lid of the same or different material. The second container comprises a vapor barrier material (e.g., made of a sheet of plastic (e.g., nylon, polyethylene, polyester, Tyvek) fortified with aluminum)). The second container is closable (e.g., sealable and/or air-tight) and it maintains a space between portions of the second container and at least about 50% of the outside area of the first container.

To prepare the product, the blended smoothie is added to the first container and then the first container with the blended smoothie is added to the second container to form the storage unit. The storage unit can then be added to a freezer for storage, including a freezer that is kept below about 10 degrees Fahrenheit.

When the storage unit with the food is removed from the freezer, it is then partially thawed (e.g., by leaving it out in a room or microwaving) to a temperature consistent with the specific food, which is often to about 20 degrees Fahrenheit, before serving. At that point, the food is ready to be consumed (it might benefit from stirring), and it will be found to have its original consistency, without undue crystallization, clumpy-ness, wateriness or breakdown of the food.

### Example 4

This example provides a storage unit for a food that is sensitive to being stored in a freezer kept at low temperatures below about 10 degrees Fahrenheit. By sensitive, it is meant that the food, when partially thawed after freezing, may have undue crystallization, clumpy-ness, wateriness, or other breakdown. The food has a desired and original consistency when first made.

The storage unit comprises a first container that contains the food and a second container that contains the first container and which maintains a space during storage of the food between portions of the second container and at least about 50% of the outside area of the first container.

The storage unit improves the storage of the food in a freezer because the food will have its original consistency (it may benefit from stirring) when thawed to a temperature of about 20 degrees Fahrenheit after storage in the freezer.

In certain preferred embodiments, the first container comprises a paper-containing material (e.g., wet-strength paperboard with a polyethylene lining) and a lid, the lid being made of the same or different materials.

In certain preferred embodiments, the second container comprises a closable plastic pouch and a vapor barrier material.

### Example 5

This example provides a method of storing a food that is sensitive to being stored in a freezer kept at low temperatures below about 10 degrees Fahrenheit. By sensitive, it is meant that the food, when partially thawed after freezing, may have undue crystallization, clumpy-ness, wateriness, or other breakdown. The food has a desired and original consistency when first made.

The method comprises (a) filling a first container with the food; (b) closing the first container with the food; (c) placing the first container with the food in a second container; (d) closing the second container; and (e) storing the second container that contains the first container with the food in the freezer.

In this method, the second container maintains a space during storage in the freezer between portions of the second container and at least about 50% of the outside area of the first container.

In addition, the method improves the storage of the food in the freezer by having the food maintain its original consistency when it is thawed to a temperature of about 20 degrees Fahrenheit after storage in the freezer.

In certain preferred embodiments, the first container comprises a paper-containing material (e.g., wet-strength paperboard with a polyethylene lining) and a lid, the lid being made of the same or different materials.

In certain preferred embodiments, the second container comprises a closable plastic pouch and a vapor barrier material.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A soft-serve ice cream product that has an original consistency when made and that can be stored in a freezer with temperatures below about 10 degrees Fahrenheit, the soft-serve ice cream product comprising:
a. soft-serve ice cream;
b. a storage unit comprising a first container and a second container;
c. the first container comprising a paper-containing material and a lid;
d. the second container comprising a vapor barrier material, the second container being closable and maintaining a space between portions of the second container and at least about 50% of the outside area of the first container; and
e. wherein the soft-serve ice cream is added to the first container, the first container with the soft-serve ice cream is added to the second container to form the storage unit, and wherein the storage unit is capable of being added to the freezer; and
f. wherein when the storage unit is removed from the freezer and the soft-serve ice cream is thawed to a temperature of about 20 degrees Fahrenheit, the soft-serve maintains its original consistency.

2. An ice cream-based beverage product that has an original consistency when made and that can be stored in a freezer with temperatures below about 10 degrees Fahrenheit, the ice cream-based beverage product comprising:
a. ice cream-based beverage;
b. a storage unit comprising a first container and a second container;
c. the first container comprising a paper-containing material and a lid;
d. the second container comprising a vapor barrier material, the second container being closable and maintaining a space between portions of the second container and at least about 50% of the outside area of the first container;
e. wherein the ice cream-based beverage is added to the first container, the first container with the ice cream-based beverage is added to the second container to form the storage unit, and the storage unit is capable of being added to the freezer; and
f. wherein when the storage unit is removed from the freezer and the ice cream-based beverage is thawed to a temperature of about 20 degrees Fahrenheit, the ice cream-based beverage has its original consistency.

3. A blended smoothie product that has an original consistency when made and that can be stored in a freezer with temperatures below about 10 degrees Fahrenheit, the blended smoothy product comprising:
a. blended smoothie;
b. a storage unit comprising a first container and a second container;
c. the first container comprising a paper-containing material and a lid;
d. the second container comprising a vapor barrier material, the second container being closable and maintaining a space between portions of the second container and at least about 50% of the outside area of the first container;
e. wherein the blended smoothie is added to the first container, the first container with the blended smoothie is added to the second container to form the storage unit, and wherein the storage unit is capable of being added to the freezer; and
f. wherein when the storage unit is removed from the freezer and the blended smoothie is thawed to a temperature of about 20 degrees Fahrenheit, the blended smoothie has its original consistency.

4. A storage unit for the storage of a food that has an original consistency when made and that is sensitive to being stored in a freezer kept at low temperatures below about 10 degrees Fahrenheit, the storage unit comprising:
a. a first container that contains the food;
b. a second container that contains the first container and which maintains a space during storage between portions of the second container and at least about 50% of the outside area of the first container; and
c. wherein the storage unit improves the storage of the food by having the food maintain its original consistency when thawed to a temperature of about 20 degrees Fahrenheit after storage in the freezer.

5. The storage unit of claim 1, wherein the first container comprises a paper-containing material and a lid.

6. The storage unit of claim 1, wherein the second container comprises a closable plastic pouch and a vapor barrier material.

7. A method of storing a food that has an original consistency when made and that is sensitive to being stored in a freezer kept at low temperatures below about 10 degrees Fahrenheit, the method comprising:
a. filling a first container with the food;
b. closing the first container with the food;
c. placing the first container with the food in a second container;
d. closing the second container;
e. storing the second container that contains the first container with the food in the freezer;
f. wherein the second container maintains a space during storage in the freezer between portions of the second container and at least about 50% of the outside area of the first container; and
g. wherein the method improves the storage of the food in the freezer by having the food maintain its original consistency when thawed to a temperature of about 20 degrees Fahrenheit after storage in the freezer.

8. The method of claim 7, wherein the first container comprises a paper-containing material and a lid.

9. The method of claim 7, wherein the second container comprises a closable plastic pouch and a vapor barrier material.
